(19) United States
(12) Patent Application Publication
(10) Pub. No.: US 2017/0151748 A1
(43) Pub. Date: Jun. 1, 2017

(54) LAMINATED NONWOVEN FABRIC

(71) Applicant: PANASONIC INTELLECTUAL PROPERTY MANAGEMENT CO., LTD., Osaka (JP)

(72) Inventors: Koji MOTOMURA, Osaka (JP); Hiroto SUMIDA, Nara (JP); Taichi NAKAMURA, Osaka (JP); Takayoshi YAMAGUCHI, Osaka (JP); Takatoshi MITSUSHIMA, Nara (JP)

(21) Appl. No.: 15/351,564

(22) Filed: Nov. 15, 2016

(30) Foreign Application Priority Data
Nov. 30, 2015 (JP) 2015-234224

(51) Int. Cl. B32B 5/02; B32B 7/12

(52) U.S. Cl. CPC B32B 5/022; B32B 7/12; B32B 5/02; B32B 2250/00

(57) ABSTRACT

A laminated nonwoven fabric includes a first nonwoven fabric containing first fibers, a second nonwoven fabric laminated on the first nonwoven fabric and containing second fibers, a third nonwoven fabric laminated on the second nonwoven fabric on an opposite side to the first nonwoven fabric and containing third fibers, and an adhesive containing a plurality of particles. Some of the plurality of particles of the adhesive is attached to the second nonwoven fabric. At least one of the first nonwoven fabric and the third nonwoven fabric is adhered to the second nonwoven fabric via the some of the plurality of particles of the adhesive. An average fiber diameter of the first fibers is larger than the average fiber diameter of the second fibers, and an average particle diameter of the plurality of particles of the adhesive is smaller than the average fiber diameter of the first fibers.

### BACKGROUND

1. Technical Field

The present disclosure relates to a laminated nonwoven fabric including a first nonwoven fabric as a base material, a second nonwoven fabric laminated on the first nonwoven fabric and containing fibers to which an adhesive is attached, and a third nonwoven fabric laminated on the second nonwoven fabric and serving as a protective layer.

2. Description of the Related Art

A nonwoven fabric of fibers is used for various applications in addition to a filter medium. In recent years, it has been examined that a nonwoven fabric using nanofibers having a fiber diameter of the order from nm to sub-μm is used for various applications such as a filter medium, from the viewpoint of increasing a surface area.

Japanese Patent Unexamined Publication No. 2008-285793 has proposed that, from the viewpoint of increasing a shape-retaining property and handle ability of an ultrafine fiber nonwoven fabric, binder particles are formed by applying an electric field to a binder solution, and ultrafine fibers formed through electrostatic spinning are brought into contact with the binder particles so that the ultrafine fibers are bonded together. Japanese Patent Unexamined Publication No. 2009-263819 has proposed that an adhesive is attached to a surface of an accumulation member by applying an electric field, and a nonwoven fabric is laminated on the surface of the accumulation member by accumulating nanofibers thereon.

### SUMMARY

The present disclosure provides a laminated nonwoven fabric which can suppress an increase in the pressure loss and also ensure high adhesive strength between nonwoven fabrics.

According to the present disclosure, there is provided a laminated nonwoven fabric including a first nonwoven fabric containing first fibers, a second nonwoven fabric laminated on the first nonwoven fabric and containing second fibers, a third nonwoven fabric laminated on the second nonwoven fabric on an opposite side to the first nonwoven fabric and containing third fibers, and an adhesive containing a plurality of particles. Some of the plurality of particles of the adhesive are attached to the second nonwoven fabric. At least one of the first nonwoven fabric and the third nonwoven fabric is adhered to the second nonwoven fabric via the some of the plurality of particles of the adhesive. An average fiber diameter of the first fibers is larger than the average fiber diameter of the second fibers, and an average particle diameter of the plurality of particles of the adhesive is smaller than the average fiber diameter of the first fibers.

According to the laminated nonwoven fabric of the present disclosure, it is possible to suppress the pressure loss and also ensure high adhesive strength between nonwoven fabrics.

### BRIEF DESCRIPTION OF THE DRAWINGS

FIG. 1 is a vertical sectional view schematically illustrating a laminated nonwoven fabric according to an embodiment of the present disclosure;

FIG. 2 is a diagram illustrating a configuration example of a manufacturing apparatus of the laminated nonwoven fabric according to the embodiment of the present disclosure;

FIG. 3 is a diagram illustrating another configuration example of a manufacturing apparatus of the laminated nonwoven fabric according to the embodiment of the present disclosure;

FIG. 4 is a schematic diagram for explaining pressing using a pair of pressure rollers one of which has an embossing surface on its circumferential surface;

FIG. 5 is a schematic diagram for explaining pressing using a pair of pressure rollers both of which have embossing surfaces on their circumferential surfaces;

FIG. 6 is a perspective view schematically illustrating an air purifier using the laminated nonwoven fabric according to the embodiment of the present disclosure;

FIG. 7 is a diagram illustrating a scanning electron microscope (SEM) observation image captured from a second nonwoven fabric side in a state in which the second nonwoven fabric is laminated on a first nonwoven fabric in Example 1 of the present disclosure; and

FIG. 8 is a diagram illustrating an SEM observation image captured from a second nonwoven fabric side after a third nonwoven fabric is peeled off from a laminated nonwoven fabric of Example 1 of the present disclosure.

### DETAILED DESCRIPTION OF PREFERRED EMBODIMENTS

Prior to description of embodiments of the present disclosure, a problem of the related art will be described briefly. In the methods disclosed in the above Japanese Patent Unexamined Publication Nos. 2008-285793 and 2009-263819, if mass per unit area of a nonwoven fabric increases, it is hard to increase the adhesive strength between a nonwoven fabric as a base material and a nonwoven fabric formed through electrostatic spinning. Generally, in a filter medium application of an air purifier or the like, a low pressure loss is required. When a laminated nonwoven fabric is manufactured by pressing respective layers, if a pressing load is too large or a large amount of adhesive is used, the adhesive strength is improved, but a pressure loss of the laminated nonwoven fabric is increased.

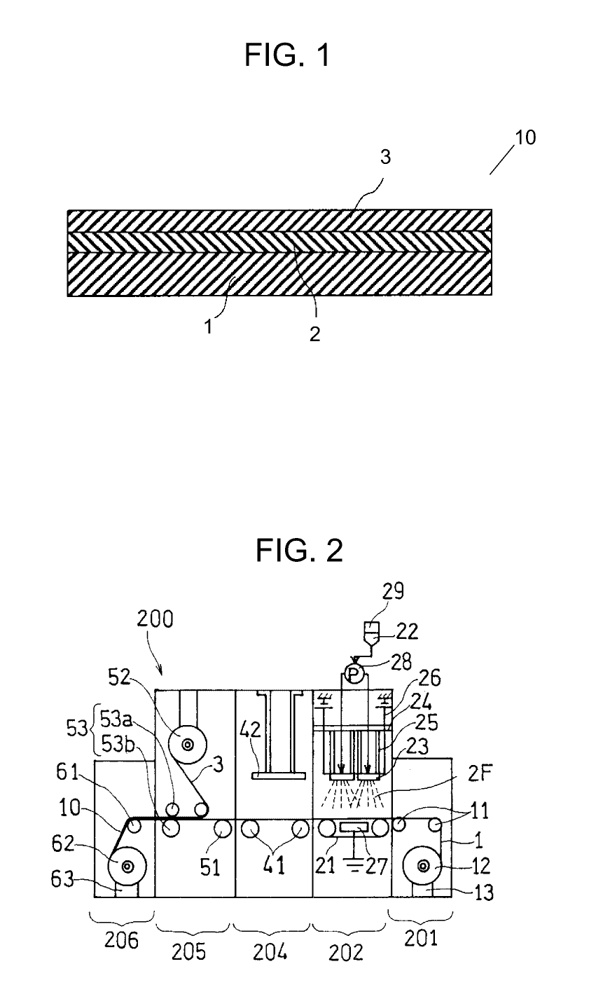

FIG. 1 is a vertical sectional view schematically illustrating laminated nonwoven fabric 10 according to the present embodiment. Laminated nonwoven fabric 10 includes first nonwoven fabric 1; second nonwoven fabric 2 laminated on one principal surface of first nonwoven fabric 1; and third nonwoven fabric 3 laminated on a principal surface of second nonwoven fabric 2 on an opposite side to first nonwoven fabric 1. First nonwoven fabric 1 contains first fibers, second nonwoven fabric 2 contains second fibers, and third nonwoven fabric 3 contains third fibers. Particles of an adhesive are attached to the second fibers. At least one of first nonwoven fabric 1 and third nonwoven fabric 3 is adhered to second nonwoven fabric 2 via the particles of the adhesive. Average fiber diameter D1 of the first fibers and average fiber diameter D2 of the second fibers satisfy a relationship of D1>D2, and average particle diameter Dp of the particles of the adhesive and average fiber diameter D1 of the first fibers satisfy a relationship of D1>Dp. The nonwoven fabric containing the fibers indicates that the fibers are contained as main components. In this case, the content of the main components is 80% by weight or greater. For example, first nonwoven fabric 1 contains, as main components, the first fibers having the average fiber diameter larger than that of the second fibers forming second nonwoven fabric 2.

In laminated nonwoven fabric 10, nonwoven fabrics forming the respective layers are adhered to each other via the adhesive. However, if the adhesive strength is increased, a pressure loss is generally increased in a filter medium application of an air purifier or the like. If mass per unit area of a nonwoven fabric increases, it is harder to increase the adhesive strength between the respective layers. If a large amount of adhesive is used in order to increase the adhesive strength even in this case, mass of laminated nonwoven fabric 10 increases, or the adhesive spills in a manufacturing process of laminated nonwoven fabric 10. If a nonwoven fabric is peeled off, dust collection efficiency is considerably reduced in a case where laminated nonwoven fabric 10 is used as a filter medium.

According to the present embodiment, since adhesive particles having a small average particle diameter are attached to the second fibers having a small average fiber diameter, it is possible to ensure a high adhesive strength between second nonwoven fabric 2, and first nonwoven fabric 1 and third nonwoven fabric 3. Therefore, it is possible to suppress peeling between the respective nonwoven fabrics. The respective nonwoven fabrics are adhered to each other via adhesive particles having a small average particle diameter, and thus it is possible to suppress an increase in the pressure loss.

The average fiber diameter is an average value of diameters of the fibers. The diameter of the fiber is a diameter of a section perpendicular to in a length direction of the fiber. In a case where such a section is not circular, a maximum diameter may be considered as the diameter. A width in a direction perpendicular to the length direction of the fiber when viewed from the normal direction of one principal surface of the nonwoven fabric (or laminated nonwoven fabric 10) may be regarded as the diameter of the fiber. The average fiber diameter is an average value of diameters of, for example, a plurality of any (for example, ten) fibers contained in the nonwoven fabric at any locations. The fiber diameter may be measured by using an electron microscope image of a nonwoven fabric (or laminated nonwoven fabric 10) containing fibers. In the above-described manner, each average fiber diameter of the first fibers, the second fibers, and the third fibers may be obtained.

Average particle diameter Dp of the adhesive particles is an average value of diameters of the adhesive particles. In a case a section of the adhesive particle is not circular, a maximum diameter may be considered as the diameter. A diameter of the adhesive particle when viewed from the normal direction of one principal surface of the nonwoven fabric (or laminated nonwoven fabric 10) may be regarded as the diameter of the adhesive particle. For example, in an electron microscope image of a nonwoven fabric containing adhesive particles, diameters of a plurality of any (for example, ten) particles selected are measured, and an average value thereof is obtained as the average particle diameter Dp. In a case where a particle is not spherical, a maximum diameter may be regarded as the diameter.

The second fibers are preferably nanofibers. In this case, nonwoven fabrics are easily adhered to each other via adhesive particles, and thus an effect of suppressing peeling between the nonwoven fabrics is increased. It is possible to further suppress an increase in the pressure loss.

Average particle diameter Dp of the adhesive particles and average fiber diameter D2 of the second fibers satisfy a relationship of Dp>D2. In this case, even in a case where a small amount of adhesive is used, since a lot of second fibers can be reinforced at a time with adhesive particles, it is possible to further increase adhesiveness and thus it becomes easier to suppress peeling between nonwoven fabrics.

Average particle diameter Dp of the adhesive particles may be less than 1 μm, but is preferably 1 μm or more, and is more preferably 5 μm or more, or 10 μm or more. Average particle diameter Dp is preferably 200 μm or less, and is more preferably 150 μm or less, or 100 μm or less. Such lower limit values and upper limit values may be combined as appropriate. Average particle diameter Dp ranges, for example, from 1 to 200 μm, inclusive, and may range from 5 to 150 μm, inclusive, or from 10 to 100 μm, inclusive. As long as average particle diameter Dp of the adhesive particles falls within this range, it becomes easier to suppress peeling between nonwoven fabrics.

The adhesive may be included in laminated nonwoven fabric 10 in a filament form. The filament may or may not be connected to an adhesive particle. A granular or filamentous adhesive may be formed by processing an adhesive according to an electrospinning method. In a case where laminated nonwoven fabric 10 also contains such filaments in addition to adhesive particles, it can be said that the adhesive is finely distributed in nonwoven fabrics. Therefore, even if an amount of used adhesive is small, peeling between nonwoven fabrics is easily suppressed. It is possible to further increase an effect of suppressing an increase in the pressure loss.

Hereinafter, a configuration of laminated nonwoven fabric 10 will be described more in detail.

(First Nonwoven Fabric)

First nonwoven fabric 1 functions as a base material for holding the shape of laminated nonwoven fabric 10. In a case of subjecting laminated nonwoven fabric 10 to pleating, first nonwoven fabric 1 works as a base material, thereby holding the shape of a pleat.

First nonwoven fabric 1 contains first fibers. Materials of the first fibers are not particularly limited, and may include, for example, glass fibers, cellulose, acrylic resin, polyolefin, polyester, or polyamide (PA). Examples of polyolefin may include polypropylene (PP) and polyethylene (PE). Examples of polyester may include polyethylene terephthalate (PET) and polybutylene terephthalate. The first fibers may contain one kind of such materials, or two or more kinds thereof. Among the materials, cellulose, polyester, and/or PA is preferably used from the viewpoint of holding the shape.

Average fiber diameter D1 of the first fibers is not particularly limited, and is, for example, in a range from 1 to 400 μm, inclusive, and is preferably in a range from 5 to 200 μm, inclusive.

First nonwoven fabric 1 is manufactured by using, for example, a spun bonding method, a dry method (for example, an air-laid method), a wet method, a melt blow method, a needle punch method, or the like, and a manufacturing method thereof is not particularly limited. Above all, first nonwoven fabric 1 is preferably manufactured by using the wet method in that it is easy to form a nonwoven fabric appropriate for a base material.

A pressure loss of first nonwoven fabric 1 is also not particularly limited, but an initial pressure loss of first nonwoven fabric 1 is preferably about 1 Pa to 10 Pa. As long as the initial pressure loss of first nonwoven fabric 1 falls within this range, an initial pressure loss of the whole of laminated nonwoven fabric 10 is also reduced. In the present specification, a pressure loss may be measured by using, for example, a measuring machine in conformity with the regulations of JIS B9908, Form 1. In the test method in the above mentioned Form 1, a pressure loss is measured as follows. A filter unit having laminated nonwoven fabric 10 is held in a unit fixer without leakage of air. A static pressure measurer is attached to the filter unit. The static pressure measurer includes straight tubes sandwiching the filter unit therebetween, and the straight tubes are provided with static pressure measurement holes, respectively, perpendicular to tube walls on an upstream side and a downstream side. In this state, a blower sends wind to the filter unit in a rated air volume. The static pressure on the upstream side and that on the downstream side are measured by manometers which are connected to the static pressure measurement holes via the tubes, respectively, and thus the pressure loss is obtained.

A thickness (T1) of first nonwoven fabric 1 ranges preferably from 50 μm to 500 μm, inclusive, and more preferably from 150 μm to 400 μm, from the viewpoint of suppressing an increase in the pressure loss as much as possible.

In the present specification, the thickness of the nonwoven fabric is, for example, an average value of thicknesses measured at a plurality of any (for example, ten) locations in a nonwoven fabric of laminated nonwoven fabric 10. The thickness is a distance between two principal surfaces of the nonwoven fabric. Specifically, in an image of a section of laminated nonwoven fabric 10 is captured, when a line perpendicular to one surface is drawn from any one point on one principal surface of the nonwoven fabric to the other principal surface, among fibers on the line, a distance between outer contour lines of two fibers which are most distant from each other is obtained as thickness of the nonwoven fabric. This is similarly performed on a plurality of any other points (for example, nine points) so that thicknesses of the nonwoven fabric are calculated, and a numerical value obtained by averaging the thicknesses is used as the thickness of the nonwoven fabric. In a case where a pressing member having an embossing surface is used to press the nonwoven fabric as will be described later, a thickness of the nonwoven fabric is reduced in a region pushed by protrusions of the embossing surface. Thus, the thickness of the nonwoven fabric is measured in regions other than the region pushed by the protrusions. When the thickness of the nonwoven fabric is calculated, an image having undergone a binarization process may be used. In the above-described manner, thickness T1 of first nonwoven fabric 1, and thickness T2 of second nonwoven fabric 2 and thickness T3 of third nonwoven fabric 3 which will be described later may be obtained.

Mass per unit area of first nonwoven fabric 1 is preferably 10 g/m² to 80 g/m², and is more preferably 35 g/m² to 60 g/m², from the viewpoint of ensuring the strength of laminated nonwoven fabric 10 and reducing a pressure loss as much as possible. The mass per unit area may be an average value of mass per unit area obtained in a plurality of (for example, ten) regions each having a predetermined area in first nonwoven fabric 1.

(Second Nonwoven Fabric)

Second nonwoven fabric 2 contains second fibers having average fiber diameter D2 smaller than average fiber diameter D1 of the first fibers, and has a function of capturing dust. Second nonwoven fabric 2 is laminated on one principal surface of first nonwoven fabric 1.

Average fiber diameter D2 is preferably 1/10 or less of average fiber diameter D1 (D2≦D1/10), and is more preferably D2≧D1/100. Average fiber diameter D2 is preferably 1/1000 or more of average fiber diameter D1 (D1/1000≦D2). As long as average fiber diameter D2 falls within this range, a pressure loss is easily suppressed and dust collection efficiency also tends to increase. Specifically, average fiber diameter D2 ranges preferably from 30 nm to 3 μm, or from 30 nm to 1 μm. The second fibers are preferably nanofibers from the viewpoint of reducing a pressure loss and further increasing dust collection efficiency. Average fiber diameter D2 of such second fibers is, for example, 30 to 800 nm, and is preferably 50 to 800 nm.

Materials of second fibers are not particularly limited, and may include, for example, polymers such as PA, polyimide (PI), polyamideimide (PAT), polyetherimide (PEI), polyacetal (POM), polycarbonate (PC), polyether ether ketone (PEEK), polysulfone (PSF), polyethersulfone (PES), polyphenylene sulfide (PPS), polytetrafluoroethylene (PTFE), polyarylate (PAR), polyacrylonitrile (PAN), polyvinylidene fluoride (PVDF), polyvinyl alcohol (PVA), polyvinyl acetate (PVAc), PP, PET, and polyurethane (PU). The polymers may be homopolymers or copolymers. The second fibers may contain one kind of such materials, or two or more kinds thereof. In a case where the second fibers are formed by using an electrostatic spinning method, PES is preferably used. PVDF is preferably used in that average fiber diameter D2 is easily reduced.

A molecular weight of a raw material resin of the second fibers is preferably larger than a molecular weight of a resin forming an adhesive. Particularly, in a case where the raw material resin of the second fibers and the resin forming the adhesive are of the same kind, the molecular weight of the raw material resin is typically larger than the molecular weight of the resin forming the adhesive. A difference M_{w2}-M_{wa} between weight-average molecular weight M_{w2} of the raw material resin of the second fibers and weight-average molecular weight M_{wa} of the resin forming the adhesive is preferably 10000 or more, and may be 20000 or more or 50000 or more.

A manufacturing method of second nonwoven fabric 2 is not particularly limited, and may be manufactured according to the method or the like described for first nonwoven fabric 1, but second nonwoven fabric 2 is manufactured according to an electrostatic spinning method. If second nonwoven fabric 2 is formed according to the electrostatic spinning method, the second fibers are accumulated on the first fibers in a concentrated manner. Thus, it becomes easier to adhere nonwoven fabrics to each other and also to suppress a pressure loss further. Manufacturing of second nonwoven fabric 2 using the electrostatic spinning method will be described more in detail in a manufacturing method of laminated nonwoven fabric 10 which will be described later.

Thickness T2 of second nonwoven fabric 2 ranges preferably from 0.5 to 50 μm (or 10 μm), and more preferably from 1 to 5 μm, from the viewpoint of reducing a pressure loss as much as possible. An initial pressure loss of second nonwoven fabric 2 is preferably from about 5 Pa to 40 Pa.

Mass per unit area of second nonwoven fabric 2 is preferably in a range from 0.05 to 8 g/m², inclusive, and is more preferably in a range from 0.5 to 7 g/m², inclusive, from the viewpoint of ensuring a low pressure loss and to further increase dust collection efficiency. As mentioned above, even in a case where the relatively thick nonwoven fabric (or the nonwoven fabric having great mass per unit area) is used as second nonwoven fabric 2, the adhesive particles having a small average particle diameter are attached to the second fibers, and thus it is possible to suppress peeling between the nonwoven fabrics.

(Third Nonwoven Fabric)

Third nonwoven fabric 3 has a function of collecting relatively large dust, and functions as a protection material for protecting second nonwoven fabric 2 from various external loads. Third nonwoven fabric 3 is laminated on the other principal surface of second nonwoven fabric 2 (a principal surface on an opposite side to first nonwoven fabric 1). Third nonwoven fabric 3 preferably has undergone a charging process from the viewpoint of dust collection efficiency.

Materials of the third fibers contained in third nonwoven fabric 3 are not particularly limited, and may be selected as appropriate from among the materials exemplified with respect to first nonwoven fabric 1. PP is preferably used in that the material is easily charged. Average fiber diameter D3 of the third fibers is not particularly limited. Average fiber diameter D3 ranges, for example, from 0.5 to 20 μm, inclusive, and preferably from 1 to 20 μm, inclusive.

A manufacturing method of third nonwoven fabric 3 is not particularly limited, and the methods exemplified in first nonwoven fabric 1 may be exemplified in the same manner. Above all, third nonwoven fabric 3 is preferably manufactured by using the melt blow method from the viewpoint that it is easy to form a nonwoven fabric having a small fiber diameter appropriate for a filter medium.

Thickness T3 of third nonwoven fabric 3 is not particularly limited, and may range from 100 to 500 μm, inclusive, and preferably from 150 to 400 μm, inclusive. Mass per unit area of third nonwoven fabric 3 is not particularly limited, and may be 10 g/m² to 50 g/m², and is preferably 10 g/m² to 30 g/m².

A pressure loss of third nonwoven fabric 3 is not particularly limited, but an initial pressure loss of third nonwoven fabric 3 is preferably about 10 Pa to 50 Pa. As long as the initial pressure loss of third nonwoven fabric 3 falls within this range, a pressure loss of the whole of laminated nonwoven fabric 10 is also reduced.

(Adhesive)

In laminated nonwoven fabric 10, adhesive particles are attached to the second fibers, and thus second nonwoven fabric 2 and first nonwoven fabric 1, and second nonwoven fabric 2 and third nonwoven fabric 3 are respectively adhered to each other via the adhesive particles. As mentioned above, the nonwoven fabrics are adhered to each other by using point adhesion of the adhesive particles, and thus it is possible to suppress peeling between the nonwoven fabrics and also to reduce a pressure loss of laminated nonwoven fabric 10. Laminated nonwoven fabric 10 may include filaments of the adhesive connected to the adhesive particles.

The adhesive particles may be attached to the second fibers by spraying a powdery adhesive onto the second fibers along with a dispersion medium, but are preferably attached to the second fibers according to an electrospinning method. If the adhesive is subjected to electrospinning, a diameter of the adhesive particle can be reduced, and thus particles of the adhesive can be finely and more uniformly distributed. If the adhesive is subjected to electrospinning, the adhesive particles easily concentrate on fibers. Therefore, it is possible to further increase an effect of reducing a pressure loss while ensuring adhesive strength between nonwoven fabrics.

Regarding the adhesive, a solution of the adhesive may be subjected to electrospinning, and the adhesive may be subjected to electrospinning (that is, electrostatic spinning) along with a raw material resin of the second fibers. If the adhesive is subjected to the electrospinning along with the raw material resin of the second fibers, when the second fibers are generated, adhesive particles are formed and are attached to the second fibers. Thus, the adhesive particles are distributed in the whole of second nonwoven fabric 2, and thus it is possible to increase an effect of suppressing peeling between second nonwoven fabric 2 and first nonwoven fabric 1, and between second nonwoven fabric 2 and third nonwoven fabric 3.

The kind of the adhesive is not particularly limited, and may be, for example, a hot melt adhesive having a thermosetting resin as a main component. The hot melt adhesive may be a reactive hot melt adhesive or a nonreactive hot melt adhesive. Specific examples of the hot melt adhesive may include an ethylene-vinyl acetate copolymer-based adhesive, a polyolefin-based adhesive, a polyester-based adhesive, a polyamide-based adhesive, an acrylic-based adhesive, a polyurethane-based adhesive, and an elastomer-based adhesive. The thermosetting resin contained in the adhesive may be homopolymers or copolymers. For example, as the polyolefin-based adhesive, PE, PP, and olefin copolymers containing ethylene units or propylene units may be exemplified. As the polyester-based adhesive, polyalkylene terephthalate such as PET, and modified polyesters such as urethane-modified copolymer polyester may be exemplified. The adhesives may be used alone or in combination of two or more kinds thereof.

In laminated nonwoven fabric 10, the adhesive particles may include first particles having streaky dents, and other second particles. The streaky dents of the first particles are fiber marks formed as a result of the adhesive particles being pressed against the fibers (the first fibers, the second fibers, and/or the third fibers). The streaky dents are preferably buried with the fibers. The first particles may be in a state of being collapsed to be spread as a result of being pressed against the fibers.

As will be described later, the first particles are formed by pushing a laminate of first nonwoven fabric 1, second nonwoven fabric 2, and third nonwoven fabric 3 by using a pressure member having an embossing surface with protrusions. If the laminate is pushed by using such a pressure member, adhesive particles present in a region facing the protrusions of the embossing surface are pressed against the fibers (the first fibers, the second fibers, and/or the third fibers), and thus the first particles having streaky dents are formed. The first particle may have a collapsed and spread shape due to being pressed against the fibers. The remaining adhesive particles as the second particles which are not pressed against the fibers (or the second particles are not pressed to be collapsed) are present at positions facing regions other than the protrusions of the embossing surface. In a case where the adhesive particles include the first particles and the second particles, average particle diameter Dp of the adhesive particles is assumed to be calculated with respect to the second particles.

Second nonwoven fabric 2, and either first nonwoven fabric 1 or third nonwoven fabric 3, or both of the two nonwoven fabrics are adhered to each other via the first particles having streaky dents (or collapsed to be spread), and thus high adhesive strength can be ensured. On the other hand, the second particles remain, and thus it is possible to further reduce a pressure loss. In order to be used as a filter medium, the number n₂ of second particles is preferably larger than the number n₁ of first particles. In order to satisfy n₂>n₁, for example, an area of other regions may be larger than an area of protrusion regions on the embossing surface. A ratio n₂/n₁ of the number n₂ of second particles to the number n₁ of first particles is preferably 1.1 to 10, and is more preferably 1.2 to 5. As long as the ratio n₂/n₁ falls within this range, it is easy to take a balance between the adhesive strength and the pressure loss.

In an electron microscope image of laminated nonwoven fabric 10, values measured in any region with a predetermined area (for example, a size of width 1 mm×height 1 mm, width 10 mm×height 10 mm, or width 50 mm×height 50 mm) may be used as values of n₁ and n₂, and values converted into values of n₁ and n₂ in the whole of laminated nonwoven fabric 10 may be used. An average value of values measured in a plurality of any regions may be used.

If the adhesive is subjected to electrospinning, a plurality of adhesive particles may be formed, and filaments may be formed from the adhesive particles so as to be stringy. The filaments are preferably very fine and are thinner than the second fibers. An average fiber diameter of the filaments is, for example, 10 to 200 nm, and may be 10 to 100 nm. The average fiber diameter of the filaments may be obtained similarly to a case of the average fiber diameter of the first fibers.

Average mass of the adhesive attached to laminated nonwoven fabric 10 is not also particularly limited, but is preferably 0.5 g/m² to 15 g/m², more preferably 1 g/m² to 10 g/m², and most preferably 3 g/m² to 9 g/m², from the viewpoint of reducing a pressure loss and easily obtaining high adhesiveness.

In laminated nonwoven fabric 10, a ratio s₂/s₁ of total area s₂ of other regions to total area s₁ of regions pushed by the protrusions of the embossing surface is, for example, 1.1 to 10, and is preferably 1.2 to 5. In laminated nonwoven fabric 10, an average thickness of third nonwoven fabric 3 in regions pushed by the protrusions of the embossing surface in third nonwoven fabric 3 is, for example, 50% to 95% of thickness T3 of third nonwoven fabric 3 measured in regions other than the regions, and is preferably 60% to 80% thereof. As long as the ratio s₂/s₁ and/or the average thickness of third nonwoven fabric 3 in the regions pushed by the protrusions fall(s) within these ranges, it is easy to increase the adhesive strength between nonwoven fabrics while reducing the pressure loss.

In laminated nonwoven fabric 10, the adhesive strength between second nonwoven fabric 2 and first nonwoven fabric 1, and the adhesive strength between second nonwoven fabric 2 and third nonwoven fabric 3 are high, and peeling therebetween is suppressed. In such laminated nonwoven fabric 10, the peeling strength between second nonwoven fabric 2 and first nonwoven fabric 1, and the peeling strength between second nonwoven fabric 2 and third nonwoven fabric 3 are 50 to 300 mN/25 mm in a case where the peeling strength is measured according to a method conforming to JIS Z0237 (corresponding to ISO 29862:2007).

(Manufacturing Method of Laminated Nonwoven Fabric)

Laminated nonwoven fabric 10 may be manufactured by disposing first nonwoven fabric 1, second nonwoven fabric 2, and third nonwoven fabric 3 in this order, and adhering second nonwoven fabric 2 and first nonwoven fabric 1 to each other, and second nonwoven fabric 2 and third nonwoven fabric 3 to each other, via adhesive particles attached to second nonwoven fabric 2. Regarding the second fibers, preferably, a raw material resin is spun through electrospinning so as to be accumulated on first nonwoven fabric 1, and thus second nonwoven fabric 2 is laminated on first nonwoven fabric 1. Adhesive particles are preferably formed by subjecting a solution containing an adhesive to electrospinning. The second fibers to which the adhesive particles are attached are more preferably formed by subjecting the raw material resin of the second fibers and the solution containing the adhesive to electrospinning.

Preferably, a manufacturing method of laminated nonwoven fabric 10 includes first to fourth steps. In the first step, first nonwoven fabric 1 containing first fibers, a raw material liquid containing a raw material resin as a raw material of second fibers and an adhesive, and third nonwoven fabric 3 containing third fibers, are prepared. In the second step, the raw material liquid is ejected from a nozzle according to an electrostatic spinning (electrospinning) method so that the second fibers to which adhesive particles are attached are generated, and the second fibers to which the adhesive particles are attached are accumulated on first nonwoven fabric 1 so that second nonwoven fabric 2 is laminated on first nonwoven fabric 1. In the third step, third nonwoven fabric 3 containing the third fibers is disposed on a principal surface of second nonwoven fabric 2 on an opposite side to first nonwoven fabric 1, and thus a laminate is obtained. In the fourth step, this laminate is pushed in a thickness direction so that second nonwoven fabric 2 and first nonwoven fabric 1, and second nonwoven fabric 2 and third nonwoven fabric 3 are pressed, and thus laminated nonwoven fabric 10 is obtained.

Hereinafter, each step will be described more in detail.

(First Step)

In the first step, first nonwoven fabric 1, the raw material liquid, and third nonwoven fabric 3 are prepared. First nonwoven fabric 1 and third nonwoven fabric 3 may be prepared according to the above-described method or the like.

As an adhesive contained in the raw material liquid, the above-exemplified adhesives are used. As a raw material resin serving as a raw material of the second fibers, a variety of polymers exemplified in the materials of the second fibers are used. Precursors of the polymers may be used as the raw material resin. For example, in a case where the second fibers are formed of PI, a PI precursor such as a polyamic acid may be used as the raw material resin. The raw material liquid typically contains a solvent in addition to the raw material resin of the second fibers and the adhesive. The solvent may be appropriately selected depending on the type of raw material resin or a manufacturing condition.

As the solvent, water or an organic solvent is used. Examples of the organic solvent may include alcohols, ethers, ketones, esters, carboxylic acids (for example, a formic acid and an acetic acid), nitriles (for example, acetonitrile), amides, nitrogen-containing heterocyclic compounds (for example, pyridine), sulfoxides (for example, dimethyl sulfoxide), phenols, hydrocarbons. Examples of the alcohols may include methanol, ethanol, 1-propanol, 2-propanol, hexafluoroisopropanol, tetraethylene glycol, triethylene glycol, and dibenzyl alcohol. As the ethers, cyclic ethers such as 1,3-dioxolane, 1,4-dioxane, and tetrahydrofuran are preferably used. Examples of the ketones may include acetone, hexafluoro acetone, methyl ethyl ketone, methyl isobutyl ketone, methyl-n-hexyl ketone, methyl-n-propyl ketone, diisopropyl ketone, diisobutyl ketone, and cyclohexanone. Examples of the esters may include methyl formate, ethyl formate, propyl formate, methyl acetate, ethyl acetate, propyl acetate, methyl benzoate, ethyl benzoate, propyl benzoate, dimethyl phthalate, diethyl phthalate, and dipropyl phthalate. Examples of the amides may include N,N-dimethylformamide, and N,N-dimethylacetamide (DMAc). Examples of the hydrocarbons may include hexane, cyclohexane, cyclopentane, benzene, toluene, xylene o-xylene, p-xylene, and m-xylene. The raw material liquid may contain one kind of such solvents, or two or more kinds thereof. An amide such as DMAc is preferred from the viewpoint of easily dissolving an adhesive or a raw material resin such as PES. The amide is a solvent appropriate for electrostatic spinning.

The raw material liquid may be prepared by dissolving the adhesive and the raw material resin into the solvent. Since the raw material liquid contains the adhesive and the raw material resin, when the second fibers are accumulated so that second nonwoven fabric 2 is laminated on first nonwoven fabric 1, the adhesive is exposed to a principal surface facing first nonwoven fabric 1 and a principal surface on an opposite side to first nonwoven fabric 1. In other words, the adhesive is distributed to both of the principal surfaces of second nonwoven fabric 2. Thus, even if a step of spraying the adhesive is not provided before and/or after second nonwoven fabric 2 is laminated, it is easy to increase the adhesive strength between second nonwoven fabric 2 and first nonwoven fabric 1, and the adhesive strength between second nonwoven fabric 2 and third nonwoven fabric 3. Therefore, it is possible to simplify manufacturing steps of laminated nonwoven fabric 10 and to save the space of a manufacturing apparatus.

In a case of using a solution containing only an adhesive, the adhesive tends to gel, but, if a raw material liquid contains an adhesive and a raw material resin, it is possible to prevent the adhesive from gelling. The reason why gelling is prevent is not clear, but it may be considered that the raw material resin is contained in the raw material liquid in addition to the adhesive, and thus crystallization or coagulation of the adhesive is suppressed.

The raw material liquid may be prepared by mixing a first solution containing an adhesive and a first solvent dissolving the adhesive with a second solution containing a raw material resin and a second solvent dissolving the raw material resin. In this case, time for a dissolving (preparation) step can be reduced, and a uniform solution can be produced. The first solution and the second solution are prepared in advance prior to preparation of the raw material liquid. The first solvent and the second solvent may be selected from among the above-exemplified solvents depending on the kind of adhesive or raw material resin. The first solvent and the second solvent may be different from each other. From the viewpoint of obtaining a uniform raw material liquid, the first solvent and the second solvent preferably have mutual compatibility, and the same solvent may be used. In a case where the first solvent and the second solvent contain the same solvent, solution preparation or nozzle cleaning is also facilitated. Taking into consideration easiness of electrostatic spinning, a case is preferred in which each of the first solvent and the second solvent is an amide such as DMAc or contains an amide such as DMAc.

A proportion of the solvent in the raw material liquid differs depending on the kind of selected solvent or the kind of adhesive or raw material resin. The proportion of the solvent in the raw material liquid is, for example, 50% by mass to 95% by mass, inclusive.

A well-known additive, anti-gelling agent, or the like may be added to the raw material liquid as necessary. An inorganic solid material may be added to the raw material liquid. Examples of the inorganic solid material may include inorganic compounds (for example, oxides, carbides, nitrides, borides, silicides, fluorides, and sulfides) containing metals and/or typical nonmetals (B, Si, P, As, and the like). The oxides are preferably used from the viewpoint of workability or the like. Specific examples of the oxides may include Al₂O₃, SiO₂, TiO₂, MgO, and CaO. The inorganic solid materials may be alone or in combination of a plurality of kinds thereof.

In the present disclosure, gelling of the raw material liquid can be suppressed, and the extent of gelling of the raw material liquid may be measured on the basis of a viscosity change of the raw material liquid. For example, an increasing ratio of the viscosity of the raw material liquid (for example, after five hours elapse from preparation of the raw material liquid) provided for electrostatic spinning to the viscosity (initial viscosity) right after the raw material liquid is prepared can be reduced to 10% or less.

(Second Step)

In the second step, the raw material liquid is subjected to electrostatic spinning so that the second fibers to which a plurality of particles of the adhesive are attached are accumulated, and thus second nonwoven fabric 2 is laminated on one principal surface of first nonwoven fabric 1. In the electrostatic spinning, the second fibers are generated by applying a high voltage to the raw material liquid, and ejecting the raw material liquid having electric charge from a nozzle. At this time, the adhesive is also ejected so as to be attached to the second fibers.

Since the adhesive has lower spinnability than that of the raw material resin of the second fibers, the adhesive does not have a clean fibrous state unlike the second fibers but has a granular state. However, filaments of the adhesive in each which one or more of particles of the adhesive are connected to each other are formed along with the adhesive particles through electrospinning. Since the adhesive has lower spinnability than that of the raw material resin of the second fibers, even if the filaments are formed, a fiber diameter thereof is considerably smaller than that of the second fiber. If the raw material liquid is subjected to electrospinning as mentioned above, the adhesive is distributed in the whole of second nonwoven fabric 2, and thus it is possible to increase an effect of suppressing peeling between second nonwoven fabric 2 and first nonwoven fabric 1 (and third nonwoven fabric 3). The reason why the spinnability of the adhesive is lower than that of the raw material resin of the second fibers is not clear, but it may be considered that the spinnability is influenced by a difference between molecular weights of the adhesive (the resin forming the adhesive) and the raw material resin of the second fibers and/or a difference in interaction force between molecules.

The raw material liquid is preferably ejected in a direction perpendicular to a surface direction of first nonwoven fabric 1. This is appropriate for manufacturing a nonwoven fabric which is relatively thin and is uniform since rising of spun rising of fibers is suppressed. The direction perpendicular to the surface direction of first nonwoven fabric 1 includes not only a direction which is completely perpendicular thereto but also a direction (for example, a range of 70° to 100° with respect to the surface direction of first nonwoven fabric 1) which is approximately perpendicular thereto.

In the second step, adhesive particles may be attached to one principal surface of first nonwoven fabric 1 through electrospinning of the solution containing the adhesive, and then second nonwoven fabric 2 may be laminated as described above, as necessary. After second nonwoven fabric 2 is laminated on first nonwoven fabric 1, adhesive particles may be attached to a principal surface of second nonwoven fabric 2 on an opposite side to first nonwoven fabric 1 through electrospinning of the solution containing the adhesive, and third nonwoven fabric 3 may be further laminated on the principal surface in the next step. In this case, it is possible to further suppress peeling between second nonwoven fabric 2 and first nonwoven fabric 1 or third nonwoven fabric 3. In the electrospinning process, the solvent is removed during formation of the adhesive particles, and thus a separate step for removing the solvent is not required to be provided.

(Third Step)

In the third step, a laminate is obtained by further disposing third nonwoven fabric 3 on second nonwoven fabric 2 laminated on first nonwoven fabric 1. Third nonwoven fabric 3 is disposed in an overlapping manner so that one principal surface of third nonwoven fabric 3 comes into contact with a principal surface of second nonwoven fabric 2 on an opposite side to first nonwoven fabric 1.

In the third step, the adhesive may be melted through heating before third nonwoven fabric 3 is disposed on second nonwoven fabric 2, as necessary. If the adhesive is temporarily melted in the third step, third nonwoven fabric 3 is easily disposed, and the adhesive is prevented from falling off. In a case where a pressure member having an embossing surface is used in the fourth step which will be described later, adhesive particles (second particles) which are not pushed by protrusions of the embossing surface easily fall off. However, the adhesive is temporarily melted in the third step, and thus falling off the adhesive can be suppressed also in the subsequent step.

For example, a heater is used to heat the adhesive. When the adhesive is heated, preferably, the adhesive is melted, and the fibers (the first fibers and the second fibers) forming the nonwoven fabrics are not melted. Thus, heating temperature or heating time may be selected as appropriate depending on the kind of adhesive, materials of the first fibers and the second fibers, and the like.

In a case where the adhesive is heated in the third step, at least a surface to which second nonwoven fabric 2 is exposed may be heated, but heating is performed so that the entire adhesive included in the laminate of first nonwoven fabric 1 and second nonwoven fabric 2 is melted, and this is effective in increasing adhesiveness between the nonwoven fabrics. The heating may be performed so that the temperature of the principal surface of second nonwoven fabric 2 on an opposite side to first nonwoven fabric 1 is, for example, 100° C. to 200° C., and is preferably 120° C. to 170° C.

(Fourth Step)

In the fourth step (pressing step), the laminate obtained in the third step is pushed in the thickness direction so that the nonwoven fabrics are adhered to each other under pressure. Laminated nonwoven fabric 10 can be obtained through the pressing. If the laminate is pushed in the fourth step in a state in which the adhesive is melted in the third step, second nonwoven fabric 2 and first nonwoven fabric 1, and second nonwoven fabric 2 and third nonwoven fabric 3 are respectively adhered to each other via the melted adhesive. The adhesive is present at least one of between second nonwoven fabric 2 and first nonwoven fabric 1, and between second nonwoven fabric 2 and third nonwoven fabric 3. In the fourth step, the laminate may be pressed while being heated as necessary. In a case where third nonwoven fabric 3 is disposed without melting the adhesive in the third step, the laminate is preferably pressed while being heated in the fourth step. In a case where the adhesive is heated in the fourth step without melting the adhesive in the third step, since a heater or a melting step for melting the adhesive can be omitted in the third step, the steps can be simplified, and a space for a device can be saved.

The laminate may be pressed by using a well-known pressure member such as a roller. In the fourth step, for example, the laminate is sandwiched between a pair of pressing rollers, and second nonwoven fabric 2 and first nonwoven fabric 1, and second nonwoven fabric 2 and third nonwoven fabric 3 are respectively adhered to each other via the adhesive by applying pressure to the laminate with the rollers. In a case where the laminate is pressed while being heated, the heating temperature is, for example, 40° C. to 200° C. In a case where the laminate is pressed with rollers, the laminate can be pressed while being heated by using heatable rollers. The heatable rollers may be, for example, rollers having heaters built thereinto, or rollers which can perform heating by using connected heaters.

In the pressure member, a principal surface (a circumferential surface in the roller) which comes into contact with the laminate may be a smooth surface. The pressure member may be provided with an embossing surface having protrusions. In the roller, the circumferential surface of the roller forms the embossing surface. A circumferential surface of one roller of a pair of rollers may be an embossing surface, and each circumferential surface of both of the rollers may be an embossing surface.

In the fourth step, if the laminate is pressed by pushing the laminate in the thickness direction on the embossing surface of the pressure member, some adhesive particles included in the laminate are pressed against the fibers by the protrusions of the embossing surface so that streaky dents are formed, and thus the first particles are formed. Second nonwoven fabric 2 and first nonwoven fabric 1, and second nonwoven fabric 2 and third nonwoven fabric 3 are respectively adhered to each other via the first particles. The other adhesive particles are present as they are as the second particles at positions facing regions other than the protrusions of the embossing surface without streaky dents being formed. In each first particle, at least a partial region of the particle may be in a state of being pressed to be collapsed, and the entire particle may be in a state of being pressed to be collapsed.

Since a diameter of the adhesive particle is small, even in a case where nonwoven fabrics are hardly adhered to each other through pressing, pressing is performed with the pressure member having the embossing surface, and thus some adhesive particles are buried with the fibers so that the first particles are formed. Therefore, it is possible to ensure adhesion between the nonwoven fabrics. On the other hand, if the laminate is pressed with a smooth pressure member under high pressure, the nonwoven fabrics can be adhered to each other even in a case where a diameter of the adhesive particle is small. However, many adhesive particles are collapsed to be spread, and thus there is a tendency for a pressure loss of laminated nonwoven fabric 10 to increase. If the laminate is pressed with the pressure member having the embossing surface, some adhesive particles remain as the second particles, and thus it becomes easier to suppress the pressure loss. From the viewpoint of suppressing the pressure loss, the number n₂ of second particles is preferably larger than the number n₁ of first particles. In order to satisfy n₂>n₁, for example, an area of other regions may be larger than an area of protrusion regions on the embossing surface.

On the embossing surface, a shape or a distribution state of the protrusion is not particularly limited. For example, the protrusions may be in a state in which a plurality of point-shaped protrusions are distributed, and may be in a state in which a plurality of linear or strip-shaped protrusions are arranged. A method of arranging the linear or strip-shaped protrusions is not particularly limited, and the protrusions may be arranged in a stripe form or a zigzag form. For example, the protrusions may be formed by winding a strip-shaped sheet on the circumferential surface of the roller. The protrusions may be formed by cutting the circumferential surface of the roller. The point-shaped protrusion may have, for example, a prismatic shape, a columnar shape, or an elliptical columnar shape. The protrusions may be formed in a grid form or a net form.

From the viewpoint of easily adjusting the ratio n₂/n₁, the ratio s₂/s₁ of total area s₂ of other regions to total area Si of protrusion regions on the embossing surface is, for example, 1.1 to 10, and is preferably 1.2 to 5. From the viewpoint of easily increasing the adhesiveness, a height of the protrusion on the embossing surface ranges preferably from 100 to 5000 μm, inclusive, and more preferably from 200 to 1000 μm, inclusive.

A material of the pressure material such as a roller is not particularly limited as long as the material has the hardness required in pressing, and, for example, well-known materials used for the pressure member, such as resins, metals, and ceramics are used. A portion (in the roller, at least the circumferential surface or the protrusion on the embossing surface) of the pressure member in contact with laminated nonwoven fabric 10 may be made of such materials.

(Manufacturing Apparatus of Laminated Nonwoven Fabric)

Laminated nonwoven fabric 10 may be manufactured by, for example, a manufacturing apparatus (or a manufacturing system) which conveys first nonwoven fabric 1 from an upstream side to a downstream side of the manufacturing line, forms second nonwoven fabric 2 on the principal surface of conveyed first nonwoven fabric 1, and then laminates third nonwoven fabric 3 thereon.

Hereinafter, with reference to FIG. 2, a description will be made of a manufacturing apparatus of laminated nonwoven fabric 10, but the following manufacturing apparatus do not limit the present disclosure. FIG. 2 is a diagram schematically illustrating an example of a configuration of the manufacturing apparatus of laminated nonwoven fabric 10. Manufacturing apparatus 200 includes a manufacturing line for manufacturing laminated nonwoven fabric 10. Manufacturing apparatus 200 includes, for example, (1) first nonwoven fabric feeding device 201 which feeds first nonwoven fabric 1 to the manufacturing line, (2) a raw material liquid tank (hereinafter, referred to as a tank) 29 which accommodates a raw material liquid containing a raw material resin as a raw material of second fibers and an adhesive, (3) electrostatic spinning device 202 which generates the second fibers by subjecting the raw material liquid supplied from tank 29 to electrostatic spinning, accumulates the second fibers to which the adhesive is attached on first nonwoven fabric 1, and laminates second nonwoven fabric 2 on first nonwoven fabric 1, (4) reel 52 as a third nonwoven fabric feeder which feeds third nonwoven fabric 3 to second nonwoven fabric 2, and (5) pressing rollers 53 as pressures which press second nonwoven fabric 2, and first nonwoven fabric 1 and third nonwoven fabric 3.

First, first nonwoven fabric 1 is prepared. In manufacturing apparatus 200, first nonwoven fabric 1 is conveyed from the upstream side of the manufacturing line to the downstream side thereof. First nonwoven fabric feeding device 201 which accommodates therein first nonwoven fabric 1 wound in a roll form is provided on the most upstream side of manufacturing apparatus 200. First nonwoven fabric feeding device 201 rotates feed reel 12 with motor 13 so as to feed first nonwoven fabric 1 wound on feed reel 12 to conveyance rollers 11 of the manufacturing line.

First nonwoven fabric 1 is conveyed to electrostatic spinning device 202 including an electrostatic spinning unit (not illustrated) by conveyance rollers 11. The electrostatic spinning mechanism provided in the electrostatic spinning unit includes discharger 23 which is provided on an upper side in the apparatus and discharges a raw material liquid containing a raw material resin of the second fibers and the adhesive, a charger (which will be described later) which positively charges the discharged raw material liquid, and conveyance conveyer 21 which is disposed to face discharger 23 and conveys first nonwoven fabric 1 from the upstream side to the downstream side. Conveyance conveyer 21 functions as a collector which collects second fibers 2F along with first nonwoven fabric 1. The number of electrostatic spinning units is not particularly limited, and may be one, or two or more.

In a case where there are a plurality of electrostatic spinning units and/or dischargers 23, an average fiber diameter of second fibers 2F to be formed may be changed for each electrostatic spinning unit or for each discharger 23, as necessary. The average fiber diameter of second fibers 2F may be changed by adjusting ejection pressure of the raw material liquid which will be described later, an applied voltage, concentration of raw material liquid, a distance from discharger 23 to first nonwoven fabric 1, temperature, humidity, and the like. An amount of accumulated second fibers 2F is controlled by adjusting ejection pressure of the raw material liquid, an applied voltage, concentration of the raw material liquid, a conveyance speed of first nonwoven fabric 1, and the like.

A plurality of discharge outlets (not illustrated) of the raw material liquid are provided on discharger 23 side facing the principal surface of first nonwoven fabric 1. Although a distance between the discharge outlet of discharger 23 and first nonwoven fabric 1 varies depending on a scale of the manufacturing apparatus or a desired fiber diameter, the distance may be, for example, 100 to 600 mm. Discharger 23 is supported by second support 25 in such a manner that its own longitudinal direction is parallel to the principal surface of first nonwoven fabric 1. Second support 25 is provided above the electrostatic spinning unit, and extends downwardly from first support 24 parallel to the conveyance direction of first nonwoven fabric 1. First support 24 may be movable so that discharger 23 is swung in a direction perpendicular to the conveyance direction of first nonwoven fabric 1.

The charger is formed of voltage applying device 26 applying a voltage to discharger 23, and counter electrode 27 provided to be parallel to conveyance conveyer 21. Counter electrode 27 is grounded (connected to the ground). Consequently, a potential difference (for example, 20 kV to 200 kV) corresponding to the voltage applied by voltage applying device 26 can be caused between discharger 23 and counter electrode 27. The configuration of the charger is not particularly limited. For example, counter electrode 27 may be negatively charged. The belt portion of conveyance conveyer 21 may be formed of a conductor instead of providing counter electrode 27.

Discharger 23 is formed of a conductor and has a long shape, and its interior is a cavity. This cavity portion (cavity) functions as an accommodator accommodating raw material liquid 22 therein. Raw material liquid 22 is supplied from raw material liquid tank 29 to the cavity of discharger 23 by a pressure produced by pump 28 communicating with the cavity of discharger 23. Raw material liquid 22 is discharged from the discharge outlet toward the principal surface of first nonwoven fabric 1 by the pressure produced by pump 28. Discharged raw material liquid 22 causes electrostatic explosion to produce a fibrous material (second fibers 2F) during movement in a charged state in a space (generation space) between discharger 23 and first nonwoven fabric 1. At this time, adhesive particles (and filaments of the adhesive) are also generated and are attached to surfaces of second fibers 2F. Generated second fibers 2F and adhesive particles (and the filaments) are accumulated on first nonwoven fabric 1 so as to form second nonwoven fabric 2.

A configuration of the electrostatic spinning mechanism forming second fibers 2F to which the adhesive particles (and the filaments) are attached is not limited thereto the above-described. A mechanism can be used without being particularly limited as long as the mechanism can generate second fibers 2F and adhesive particles (and filaments) from raw material liquid 22 by electrostatic force in a generation space of predetermined fibers, and can accumulate generated second fibers 2F and adhesive particles (and filaments) on the principal surface of first nonwoven fabric 1. The nozzle is not particularly limited, and may be, for example, a V-shaped nozzle whose shape of a section perpendicular to the longitudinal direction of the discharger is gradually reduced downward from the top, or a needle-type nozzle.

The adhesive may be melted by heating device 204 including heater 42 before third nonwoven fabric 3 is laminated on second nonwoven fabric 2. In heating device 204, a solvent contained in second nonwoven fabric 2 is also removed. Manufacturing apparatus 200 is not necessarily required to include heating device 204, but, in a case where heating device 204 is included, it is possible not only to easily increase the adhesive strength between nonwoven fabrics but also to suppress falling off of the adhesive particles in the subsequent steps.

Next, second nonwoven fabric 2 laminated on first nonwoven fabric 1 is conveyed to third nonwoven fabric laminate device 205 by conveyance rollers 41 and 51. In third nonwoven fabric laminate device 205, third nonwoven fabric 3 is fed to the principal surface of second nonwoven fabric 2 from an upper side. In a case where third nonwoven fabric 3 is long, third nonwoven fabric 3 may be wound on reel 52 in the same manner as first nonwoven fabric 1. In this case, third nonwoven fabric 3 is unwound from reel 52 and is disposed on the principal surface of second nonwoven fabric 2.

After third nonwoven fabric 3 is disposed on the principal surface of second nonwoven fabric 2, an obtained laminate is sandwiched and pushed between the pressures having a pair of vertically disposed pressing rollers 53 (pressing rollers 53a and 53b). Thus, second nonwoven fabric 2 and first nonwoven fabric 1, and second nonwoven fabric 2 and third nonwoven fabric 3 are respectively adhered to each other via the adhesive particles (and the filaments), and thus laminated nonwoven fabric 10 is formed.

Finally, laminated nonwoven fabric 10 is conveyed from third nonwoven fabric laminate device 205, and is then conveyed to collecting device 206 which is disposed on the further downstream side, via roller 61. For example, collecting device 206 has therein collecting reel 62 for winding conveyed laminated nonwoven fabric 10 thereon. Collecting reel 62 is rotatably driven by motor 63.

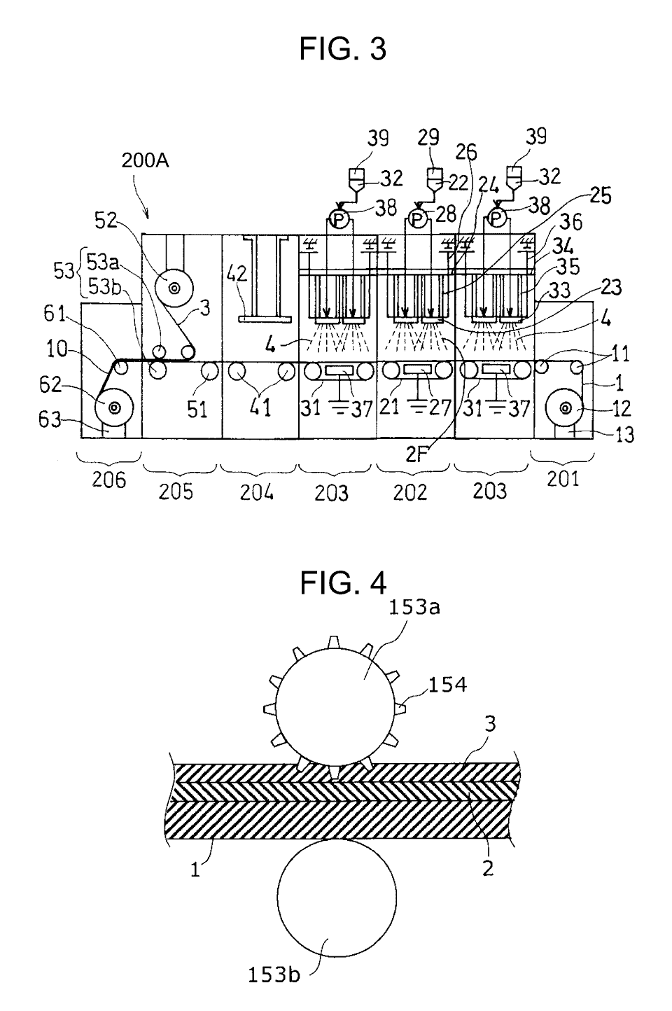

FIG. 3 is a schematic diagram illustrating another configuration example of a manufacturing apparatus of laminated nonwoven fabric 10. In manufacturing apparatus 200A in FIG. 3, adhesive spraying devices 203 are respectively provided before and after electrostatic spinning device 202 in addition to the configuration illustrated in FIG. 2.

Before second nonwoven fabric 2 is formed, first nonwoven fabric 1 may be conveyed to adhesive spraying device 203 as necessary. In adhesive spraying device 203, an adhesive is sprayed from an upper side of first nonwoven fabric 1. The adhesive may be sprayed according to, for example, a spray method or a free fall method, but may be applied on the principal surface of first nonwoven fabric 1 according to an electrospinning method by using the same device as a device similar to electrostatic spinning device 202. Similarly, after second nonwoven fabric 2 is formed, second nonwoven fabric 2 laminated on first nonwoven fabric 1 may be conveyed to adhesive spraying device 203 as necessary. In a case where a plurality of electrostatic spinning devices 202 are provided, adhesive spraying devices 203 may be provided between the plurality of electrostatic spinning devices 202.

Adhesive spraying device 203 may be provided either before or after electrostatic spinning device 202. A well-known additive or anti-gelling agent may be added to an adhesive solution.

First nonwoven fabric 1 is conveyed to adhesive spraying device 203 by conveyance rollers 11. An electrospinning mechanism provided in adhesive spraying device 203 includes discharger 33, a charger, and conveyance conveyer 31. Discharger 33 is provided on an upper side in the apparatus and discharges adhesive solution 32 containing an adhesive and a solvent. The charger positively charges discharged adhesive solution 32. The conveyance conveyer 31 conveys first nonwoven fabric 1 which is disposed to face discharger 33, from the upstream side to the downstream side.

The number of discharger 33 is not particularly limited, and may be one, or two or more. A plurality of discharge outlets (not illustrated) of the adhesive solution are provided on discharger 33 side facing the principal surface of first nonwoven fabric 1. Discharger 33 is supported by second support 35 in such a manner that its own longitudinal direction is parallel to the principal surface of first nonwoven fabric 1. Second support 35 is provided above, and extends downwardly from first support 34 parallel to the conveyance direction of first nonwoven fabric 1. First support 34 may be movable so that discharger 33 is swung in a direction perpendicular to the conveyance direction of first nonwoven fabric 1.

The charger is formed of voltage applying device 36 applying a voltage to discharger 33, and counter electrode 37 provided to be parallel to conveyance conveyer 31. Counter electrode 37 is grounded (connected to the ground). The belt portion of conveyance conveyer 31 may be formed of a conductor instead of providing counter electrode 37.

Discharger 33 is formed of a conductor and has a long shape, and its interior is a cavity. This cavity portion (cavity) functions as an accommodator accommodating adhesive solution 32 therein. Adhesive solution 32 is supplied from raw adhesive solution tank 39 to the cavity of discharger 33 by a pressure produced by pump 38 communicating with the cavity of discharger 33. Adhesive solution 32 is discharged from the discharge outlet toward the principal surface of first nonwoven fabric 1 by the pressure produced by pump 38. Discharged adhesive solution 32 becomes particles of adhesive 4 during movement in a charged state in a space (generation space) between discharger 33 and first nonwoven fabric 1. At this time, filaments of adhesive 4 may be formed. The generated particles of adhesive 4 (and the filaments of adhesive 4) are attached to the principal surface of first nonwoven fabric 1.

Adhesive spraying device 203 disposed after electrostatic spinning device 202 is the same as adhesive spraying device 203 disposed before electrostatic spinning device 202 except that adhesive 4 is sprayed onto the principal surface of second nonwoven fabric 2 laminated on first nonwoven fabric 1 fed from electrostatic spinning device 202.

In adhesive solution tank 39 or raw material tank 29, adhesive solution 32 or raw material liquid 22 may be stirred continuously or conclusively so that gelling of adhesive 4 is suppressed.

In a case where a size of the adhesive particle is small, and a circumferential surface of pressing roller 53 which is a pressure member forming the pressure is smooth, it may be hard to increase adhesive strength. If pressing is performed under high pressure in order to increase the adhesive strength, a pressure loss tends to increase. In this case, if a pressure member having an embossing surface is used, it is possible to further increase the adhesive strength between nonwoven fabrics while reducing a pressure loss. In a case where pressing rollers 53 are used, embossing surfaces may be provided on circumferential surfaces thereof. The embossing surface may be provided in one of a pair of pressing rollers 53, and may be provided in both of the rollers.

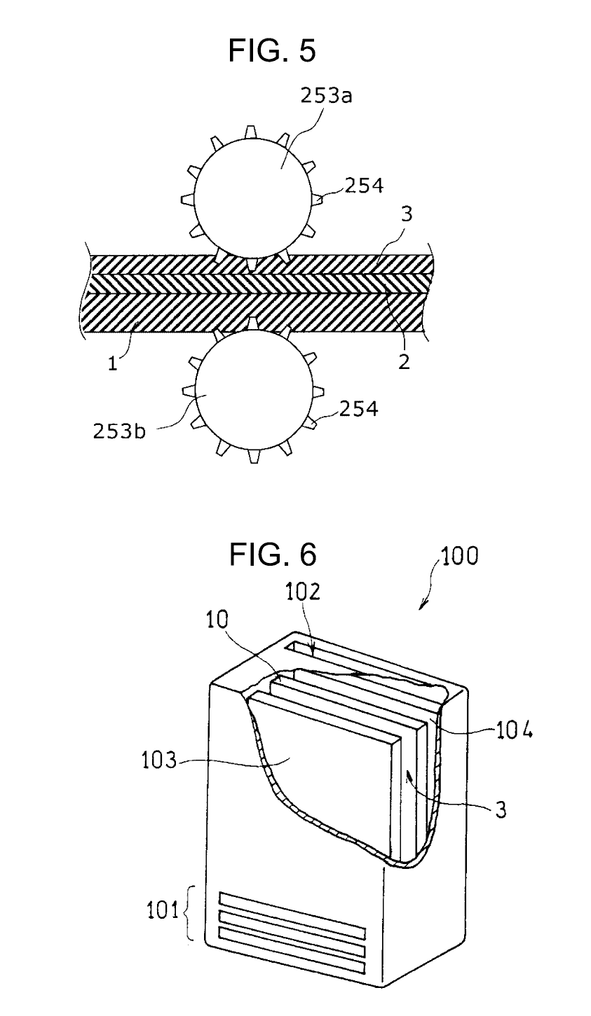

FIGS. 4 and 5 are schematic diagrams for explaining pressing using pressing rollers having an embossing surface on circumferential surfaces thereof. In FIG. 4, of a pair of pressing rollers, pressing roller 153a has a circumferential surface as an embossing surface on which a plurality of protrusions 154 are formed, and a circumferential surface of pressing roller 153b is a smooth surface. FIG. 4 illustrates an example in which upper pressing roller 153a has the embossing surface, but this case is only an example, and an embossing surface may be disposed in only the lower roller. FIG. 5 illustrates an example in which embossing surfaces are respectively disposed on circumferential surfaces of both of a pair of pressing rollers 253a and 253b. Each of the embossing surfaces of pressing rollers 253a and 253b has a plurality of protrusions 254.

As described above, the laminate of first nonwoven fabric 1, second nonwoven fabric 2, and third nonwoven fabric 3 may be pressed while being heated. In a case where the laminate is heated, it is efficient to press the laminate with a heated roller. Of a pair of rollers, one roller may perform heating, or both of the rollers may perform heating. In a case where a roller having an embossing surface and a roller whose circumferential surface is a smooth surface are used, either one of the rollers may be perform heating. From the viewpoint of efficiently burying adhesive particles with fibers, it is advantageous that a roller having an embossing surface can perform heating. From the viewpoint of easily increasing the adhesive strength, it is advantageous to press a laminate while heating the laminate in a case where heating device 204 is not used.

### Air Purifier

FIG. 6 is a perspective view of air purifier 100 including laminated nonwoven fabric 10 according to the present embodiment. Air purifier 100 includes sucker 101 of a gas, discharger 102 of the gas, and laminated nonwoven fabric 10 disposed between sucker 101 and discharger 102 of the gas. Laminated nonwoven fabric 10 may be subjected to pleating in a pleated state and arranged. Laminated nonwoven fabric 10 is a filter medium capturing dust in the air. The air purifier including laminated nonwoven fabric 10 has a low pressure loss and excellent dust collection efficiency. From the viewpoint of dust collection efficiency, laminated nonwoven fabric 10 is preferably disposed between sucker 101 and discharger 102 so that third nonwoven fabric 3 is located to face sucker 101.

Air purifier 100 takes the external air from sucker 101 into the inside of air purifier 100. The taken air is subjected to dust collection during a time when the air passes through laminated nonwoven fabric 10 and the like, and the cleaned air is again discharged from discharger 102 into the outside. Air purifier 100 may further include pre-filter 103 for capturing a large dust or the like between sucker 101 and laminated nonwoven fabric 10. Air purifier 100 may include a deodorizing filter 104 or a humidifying filter (not illustrated) between laminated nonwoven fabric 10 and discharger 102.

### EXAMPLES

Hereinafter, the present disclosure will be described in detail on the basis of Examples and comparative examples, but the present disclosure is not limited to such Examples.

### Example 1

The laminated nonwoven fabric is manufactured in the following procedures. First, the first nonwoven fabric (thickness: 300 μm, D1: 15 μm, and mass per unit area: 42 g/m²) composed of cellulose fibers, polyester fibers, and acryl fibers is prepared. The second fibers to which adhesive particles and filaments of an adhesive are attached are accumulated on the conveyed first fibers so as to laminate the second nonwoven fabric thereon by using the manufacturing apparatus illustrated in FIG. 2. As a raw material liquid of the second fibers, a solution is used in which a DMAc solution (first solution) containing the concentration of 20% by mass of the adhesive (a polyester-based hot melt resin, melting point: about 100° C.) is mixed with a DMAc solution (second solution) containing the concentration of 20% by mass of PES in a mass ratio of 1:1. Average fiber diameter D2 of the obtained second fibers 273 nm, and average mass per unit area of the second nonwoven fabric is 0.93 g/m².

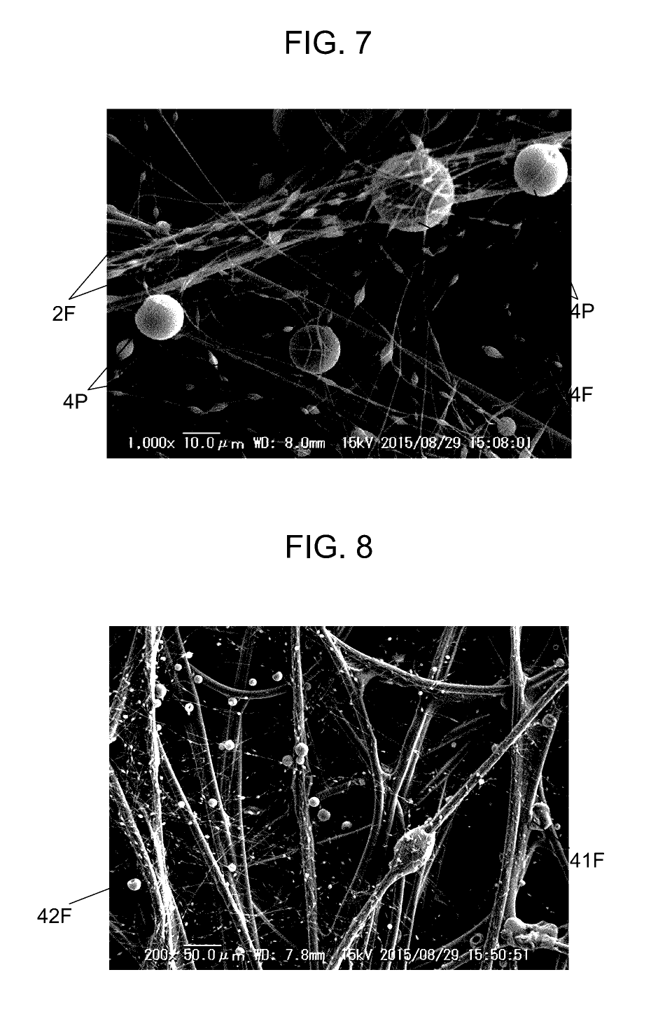

An SEM image captured from the second nonwoven fabric side is illustrated in FIG. 7. Particles 4P of the adhesive are attached to second fibers 2F, and filament 4F of the adhesive which is formed to be stringy is also observed.

Next, the surface of the second nonwoven fabric is heated to 158° C. from the second nonwoven fabric side, and then a melt blow nonwoven fabric (thickness: 165 μm, D3: 5 μm, and mass per unit area: 18 g/m²) composed mainly of polypropylene fibers are laminated on the second nonwoven fabric side as the third nonwoven fabric. The obtained laminate is fed between a pair of pressing rollers, and is pushed in a thickness direction so as to be pressed, and thus the laminated nonwoven fabric is manufactured. As one of the pair of pressing rollers, a roller is used which has an embossing surface on which a plurality of protrusions (a columnar shape of diameter 5 mm×height 1 mm, and a distance of 10 mm between adjacent protrusions) as a circumferential surface thereof. The pressure in the pressing is 10 kPa.

A sample of 30 cm² is cut out of the obtained laminated nonwoven fabric, and is folded in a pleated state (pleat width: 2.5 cm). Next, the laminated nonwoven fabric is spread, and a surface of the third nonwoven fabric side is checked with a microscope, but floating (peeling) of the third nonwoven fabric is not found. Thickness T2 of the second nonwoven fabric in the laminated nonwoven fabric is 2.3 μm.

A sample having a width of 25 mm×a length of 200 mm is separately cut out of the laminated nonwoven fabric, and the peeling strength of the sample between the first nonwoven fabric and the third nonwoven fabric is measured according to a method conforming to JIS Z0237. The peeling strength is 88 mN/25 mm.

FIG. 8 illustrates an SEM image captured from the second nonwoven fabric side after the third nonwoven fabric is peeled off from the laminated nonwoven fabric. Whereas, in a left region of the image, a small particle of the adhesive is maintained in a spherical shape, in a right region of the image, a particle of the adhesive is collapsed to be spread, a streaky dent in which fibers are buried is formed, and the adhesive particle is adhered to the fibers. In other words, the former is second particle 42P, and the latter is first particle 41P. Portions where the fibers are buried in the adhesive particles correspond to the protrusions of the embossing surface of the pressing roller, and portions where the adhesive particles are maintained in a spherical shape correspond to regions other than the protrusions. In any region of height 10 mm×width 10 mm selected from the SEM image, the number n₁ of first particles and the number n₂ of second particles are measured, and an obtained ratio n₂/n₁ is 3.4.

### Comparative Example 1

An adhesive is ejected onto one principal surface of the same first nonwoven fabric as in Example 1 through electrospinning by using a DMAc solution containing the concentration of 20% by mass of the adhesive (a polyester-based hot melt resin, melting point: about 100° C.). Next, the second fibers are accumulated on the principal surface of the first nonwoven fabric to which the adhesive is attached by using a DMAc solution containing the concentration of 20% by mass of PES as a raw material liquid in the same manner as in Example 1, and thus the second nonwoven fabric is laminated thereon.

Next, the surface of the second nonwoven fabric is heated to 158° C. from the second nonwoven fabric side, and then the same third nonwoven fabric as in Example 1 is laminated on the second nonwoven fabric side. The obtained laminate is fed between a pair of pressing rollers having smooth surfaces as circumferential surfaces thereof, and is pushed in a thickness direction so as to be pressed, and thus the laminated nonwoven fabric is manufactured. The pressure in the pressing is 10 kPa.

A sample of 30 cm² is cut out of the obtained laminated nonwoven fabric, and is folded in a pleated state in the same manner as in Example 1. The sample is spread, and a surface of the third nonwoven fabric side is checked with a microscope. As a result, floating (peeling) of the third nonwoven fabric is observed. According to the same method as in Example 1, the peeling strength is separately measured, and is 43 mN/25 mm.

### Comparative Example 2

The second fibers are accumulated on one principal surface of the same first nonwoven fabric as in Example 1 by using a DMAc solution containing the concentration of 20% by mass of PES as a raw material liquid in the same manner as in Example 1, and thus the second nonwoven fabric is laminated thereon. Next, an adhesive is ejected onto a principal surface of the second nonwoven fabric through electrospinning by using a DMAc solution containing the concentration of 20% by mass of the adhesive (a polyester-based hot melt resin, melting point: about 100° C.).

The surface of the second nonwoven fabric is heated to 158° C. from the second nonwoven fabric side to which the adhesive is attached, and then the same third nonwoven fabric as in Example 1 is laminated on the second nonwoven fabric side. The obtained laminate is fed between a pair of pressing rollers having smooth surfaces as circumferential surfaces thereof, and is pushed in a thickness direction so as to be pressed, and thus the laminated nonwoven fabric is manufactured. The pressure in the pressing is 10 kPa.

A sample of 30 cm² is cut out of the obtained laminated nonwoven fabric, and is folded in a pleated state in the same manner as in Example 1. The sample is spread, and a surface of the third nonwoven fabric side is checked with a microscope. As a result, floating (peeling) of the third nonwoven fabric is observed. According to the same method as in Example 1, the peeling strength is separately measured, and is 35 mN/25 mm.

In the laminated nonwoven fabric of the present disclosure, peeling between the nonwoven fabrics is suppressed. Therefore, the laminated nonwoven fabric of the present disclosure is appropriate for a filter medium of an air purifier or an air conditioner, a separation sheet for a battery, a membrane for a fuel cell, an extracorporeal inspection sheet such as a pregnancy test sheet, a medical sheet for cell culture, a dustproof cloth such as a dustproof mask or a dustproof wear, a cosmetic sheet, a wiping sheet for wiping dust, and the like.

What is claimed is:

1. A laminated nonwoven fabric comprising:
a first nonwoven fabric containing first fibers;
a second nonwoven fabric laminated on the first nonwoven fabric and containing second fibers;
a third nonwoven fabric laminated on the second nonwoven fabric on an opposite side to the first nonwoven fabric and containing third fibers; and
an adhesive containing a plurality of particles,
wherein some of the plurality of particles of the adhesive are attached to the second nonwoven fabric,
wherein at least one of the first nonwoven fabric and the third nonwoven fabric is adhered to the second nonwoven fabric via the some of the plurality of particles of the adhesive,
wherein an average fiber diameter of the first fibers is larger than an average fiber diameter of the second fibers, and
wherein an average particle diameter of the plurality of particles of the adhesive is smaller than the average fiber diameter of the first fibers.

2. The laminated nonwoven fabric according to claim 1,
wherein the second fibers are nanofibers.

3. The laminated nonwoven fabric according to claim 1,
wherein the average particle diameter of the plurality of particles of the adhesive is larger than the average fiber diameter of the second fibers.

4. The laminated nonwoven fabric according to claim 1,
wherein the average particle diameter of the plurality of particles of the adhesive is in a range from 1 to 200 μm, inclusive.

5. The laminated nonwoven fabric according to claim 1,
wherein the adhesive further contains a filament, and
wherein the filament is connected to any one of the plurality of particles of the adhesive.
